(19) United States
(12) Patent Application Publication
(10) Pub. No.: US 2023/0385706 A1
(43) Pub. Date: Nov. 30, 2023

(54) DATA SELECTION FOR MACHINE LEARNING MODELS BASED ON DATA PROFILING

(71) Applicant: INTERNATIONAL BUSINESS MACHINES CORPORATION, ARMONK, NY (US)

(72) Inventors: Paulina Toro Isaza, White Plains, NY (US); Yu Deng, Yorktown Heights, NY (US); Michael Elton Nidd, Zurich (CH); Harshit Kumar, Delhi (IN); Larisa Shwartz, Greenwich, CT (US)

(21) Appl. No.: 17/804,218

(22) Filed: May 26, 2022

(51) Int. Cl. G06N 20/20; G06K 9/62

(52) U.S. Cl. CPC G06N 20/20; G06K 9/6228; G06K 9/6262

(57) ABSTRACT

A method, computer system, and a computer program for data selection is provided. The present invention may include generating a first model associated with a dataset. The present invention may further include determining a first model performance level associated with the first model based on a plurality of dataset metric values of the dataset. The present invention may further include a plurality of data subsets of a dataset based on the first model performance level failing to exceed a performance threshold and calculating a plurality of subset metric values associated with the plurality of data subsets. The present invention may further include generating a second model associated with at least one data subset based on the plurality of subset metric values and determining an optimization associated with the first model based on a second model performance level associated with the second model exceeding the performance threshold.

### BACKGROUND

The present invention relates generally to the field of computing, and more particularly to machine learning.

Machine learning model performance varies significantly based on the attributes and quality of the data, and in some instances the data is limited to its inherent environment or other restrictions (such as portability issues due to data privacy/security requirements). Current data profiling and selection techniques focus primarily on numeric and categorical variables, which creates limitations with the quality of ascertainable metrics utilized to optimize machine learning models. For example, performance and accuracy metrics may be utilized to evaluate the performance of machine learning models; however, the utilization of said metrics may be confined to security limitations imposed by current data profiling strategies (e.g., specific domain/technology knowledge, computing resource allocation, etc.). As a result, in order for optimization of model performance for data structures within secure environments to occur, there must be not only a transmission of confidential information within the secure environment, but also an exhaustive amount of computing resources and memory is required for data profiling of multiple datasets.

### SUMMARY

Additional aspects and/or advantages will be set forth in part in the description which follows and, in part, will be apparent from the description, or may be learned by practice of the invention.

According to one exemplary embodiment, a computer-implemented method for data selection for machine learning models is provided. A computer generates a first model associated with a dataset; the computer determines a first model performance level associated with the first model based on a plurality of dataset metric values of the dataset and identifies a plurality of data subsets of a dataset based on the first model performance level failing to exceed a performance threshold. The computer further calculates a plurality of subset metric values associated with the plurality of data subsets; generates a second model associated with at least one data subset based on the plurality of subset metric values; and determines an optimization associated with the first model based on a second model performance level associated with the second model exceeding the performance threshold. A computer system, a computer program product, and a system for data selection for machine learning models corresponding to the above method are also disclosed herein.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a functional block diagram illustrating a computational environment for data selection according to at least one embodiment;

FIG. 2 illustrates an exemplary block diagram illustrating a data flow associated with the environment of FIG. 1, according to at least one embodiment;

FIG. 3 illustrates a flowchart illustrating a process for data selection according to at least one embodiment;

FIG. 4 illustrates a flowchart illustrating a process for data profiling according to at least one embodiment;

FIG. 5 depicts a block diagram illustrating components of the software application of FIG. 1, in accordance with an embodiment of the invention;

FIG. 6 depicts a cloud-computing environment, in accordance with an embodiment of the present invention; and

FIG. 7 depicts abstraction model layers, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for data selection for machine learning models (i.e., artificial intelligence models). Machine learning model performance and optimization is currently limited to the quality of the data associated with the model. Current techniques for data selection and data profiling are limited to data environment-specific limitations (e.g., domain-specification, data privacy rules, etc.), which ultimately impacts model optimization. For example, in instances in which third parties are tasked with handling data of an entity that has a secure data environment, it is not only costly in time and resources to ascertain metrics beyond text metrics, but also transformation of confidential data is required. In addition, optimization of machine learning models utilizing subsets of an original dataset usually requires a brute force approach by building a model for all possible sub-selection criteria, which is not only prohibitively expensive in terms of processing and memory but also requires domain and technical-specific knowledge. As such, the present embodiments have the capacity to perform profiling and selection of data subsets within secure environments in a manner in which data subsets are identified as candidates without requiring exhaustive searches; thus, reducing required computing resources while optimizing machine learning models.

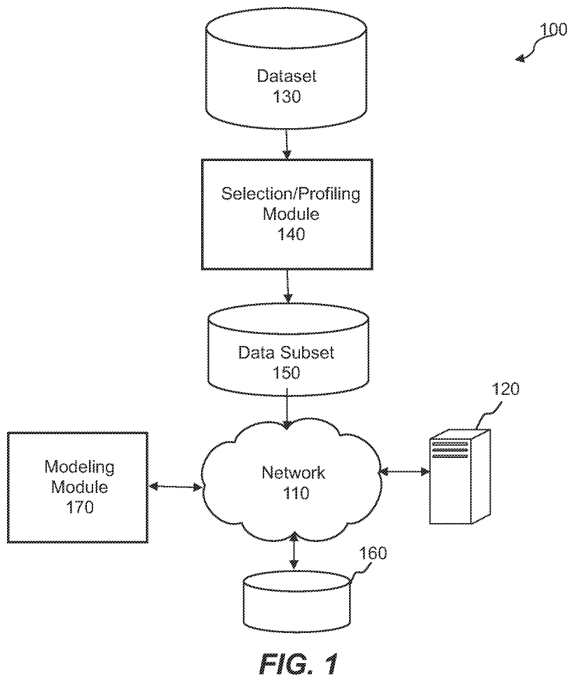

Referring now to FIG. 1, an environment for data selection 100 is depicted according to an exemplary embodiment. FIG. 1 provides only an illustration of implementation and does not imply any limitations regarding the environments in which different embodiments may be implemented. Modifications to environment 100 may be made by those skilled in the art without departing from the scope of the invention as recited by the claims. In some embodiments, environment 100 includes a server 120, a dataset 130, a selection/profiling module 140 configured to determine one or more data schemas and statistical profiles of dataset 130, data subset(s) 150 derived from dataset 130, a database 160, and a modeling module 170, each of which are communicatively coupled over network 110. Network 110 may include various types of communication networks, such as a wide area network (WAN), local area network (LAN), a telecommunication network, a wireless network, a public switched network and/or a satellite network, etc. In some embodiments, network 110 may be embodied as a physical network and/or a virtual network. A physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. In some embodiments, network 110 is configured as public cloud computing environments, which can be providers known as public cloud services providers. Embodiments herein can be described with reference to differentiated fictitious public computing environment (cloud) providers. The applicable computing devices of environment 100 may include one or more of a wearable device, a mobile device, a telephone, a personal digital assistant, a netbook, a laptop computer, a tablet computer, a desktop computer, or any applicable type of computing devices capable of running a program, accessing a network, and/or accessing the databases. It should be appreciated that FIG. 1 provides only an illustration of one implementation and does not imply any limitations with regard to the environments in which different embodiments may be implemented. Many modifications to the depicted environments may be made based on design and implementation requirements.

In some embodiments, server 120 is configured to generate a centralized platform configured to enable one or more users (e.g., data scientist) to view the functions, operations, and analytics of environment 100 and its components. For example, server 120 may continuously receive tickets for processing which pertain to one or more services within service catalogues. A service catalog refers to a taxonomy of offerings and is often proposed by a company or an organization to deal with their IT service management. Within IT systems, many problems or requests (e.g., change and service tickets) can occur (such as network slowdowns, database reboots, OS functionality, etc.) that are very time consuming to resolve as information is passed back and forth from human to human. These tickets are repetitive in nature and are addressed by service providers on a regular basis; however, they may include sensitive data specific to the company or organization. Thus, the present embodiments allow automated ascertaining of datasets, derived analytics, and improved model performance without requiring specific domain and technical knowledge.

In some embodiments, dataset 130 includes a plurality of change tickets and/or incidents tickets relating to an information technology infrastructure; however, issue tickets, compilations of data, and any other applicable type of datasets are within the spirit and scope of the disclosure. Selection/profiling module 140 is configured to perform one or more pre-processing and processing steps such as risk modeling in order to not only ascertain quantifiable metrics associated with changes to the tickets, but also to model risk languages of the change tickets via mechanisms such as hash maps or bags-of-words. It should be noted that in the instances in which selection/profiling module 140 performs pre-processing, pre-configured filters derived from server 120 or filters applied by users on the centralized platform may be applied in order for selection/profiling module 140 to perform tokenization into individual words within the textual descriptions of the change tickets. Selection/profiling module 140 may further be configured to perform functions including but not limited to removing stop words within textual descriptions (e.g., “the”, “a”, etc.) after the tokenization, stemming/lemmatization to identify root words within textual description, domain- or language-specific processing, or any other applicable configuring/filtering functions known to those of ordinary skill in the art. Change tickets within dataset 130 may be categorized, labeled, mapped, linked, etc. upon one or more classes predicted by selection/profiling module 140 utilizing one or more artificial intelligence models provided by modeling module 170. In some embodiments, the aforementioned risk languages are designed to be stored in a dictionary, hash map, and/or bag housed within database 160.

It should be noted that one of the purposes of selection/profiling module 140 is to filter and select data subsets 150 from dataset 130 utilizing the aforementioned mechanisms, in which data metrics of data subsets 150 will be ascertained upon applying the aforementioned filters. In some embodiments, the change tickets are filtered based on their “close codes” (e.g., specific code issued once ticket has been resolved); however, other applicable filtering mechanisms may be applied by users via inputs received by server 120 on the centralized platform.

In some embodiments, selection/profiling module 140 is designed to generate one or more data-profiling models configured to utilize statistics information of dataset 130 to classify the data elements in the dataset. Selection/profiling module 140 may further generate a statistical profile of dataset 130. A statistical profile may include a plurality of descriptive metrics. For example, the statistical profile may include an average, a mean, a standard deviation, a range, a moment, a variance, a covariance, a covariance matrix, a similarity metric, or any other statistical metric of dataset 130.

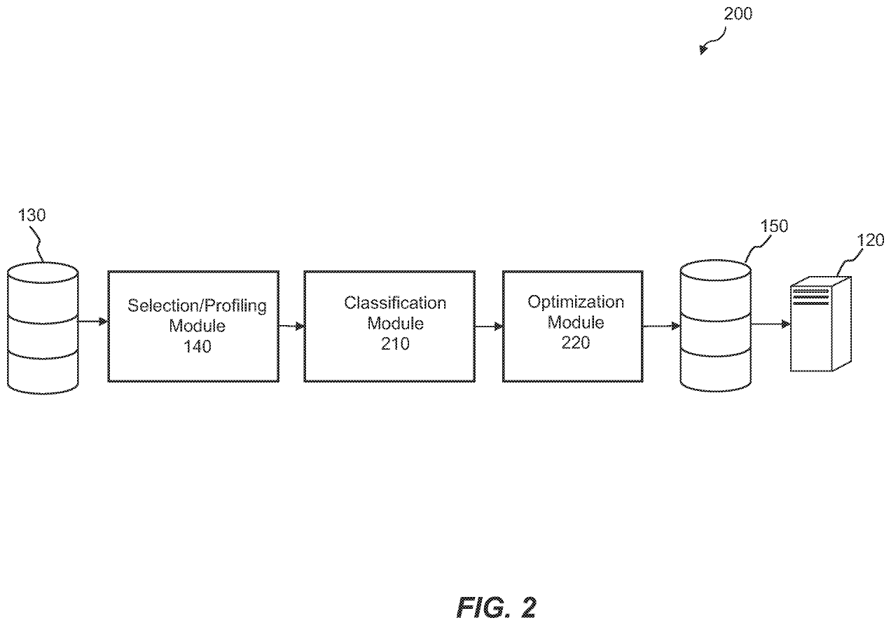

Referring now to FIG. 2, a data flow 200 associated with environment 100 is depicted, according to an exemplary embodiment. In some embodiments, server 120 is communicatively coupled to a classification module 210 designed to train one or more data classification models configured to identify one or more classes among dataset 130 and/or data subset 150. Classification module 210 is configured to retrain applicable models (i.e., previous iterations) in order to ascertain additional classes/categories if necessary. It should be noted that progressively improving machine model performance may be accomplished by a process called labeling. As described herein “labeling” is the process of sampling a dataset (e.g., generating a subset of the data) and associating the subset of the data with a data category to which the subset belongs to. In some embodiments, selection/profiling module 140 utilizes one or more reference metrics generated by modeling module 170 in order for server 120 and/or selection/profiling module 140 to compare metrics ascertained from dataset 130 to, allowing users to ascertain whether the particular model of dataset 130 and/or subset 150 is performing up to standard. It should be noted that the reference metrics are a reference dataset which may be established by either one or more iterations of modeling module 170 or server 120 in order to ascertain a spectrum of performance of models and data quality utilized for said models.

One of the purposes of classification module 210 is to provide classes and classification labels for selection/profiling module 140 to establish one or more performance metrics across, in which the one or more metrics are ascertained via selection/profiling module 140 analyzing categorical and text specific metrics on each classification label or class output by classification module 210. There may be a distinct classifier for each known ticket classification, such that a ticket may have multiple classifications or a single classifier may be used to determine a single appropriate ticket classification. In a preferred embodiment, classification module 210 iterates one or more classification models on dataset 130 after selection/profiling module 140 performs data profiling in which the classification models after each iteration outputs either “satisfactory” or “unsatisfactory” performance of the respective model based on the performance metrics exceeding or failing to exceed a performance threshold established by one or more of server 120 or modeling module 170. The performance threshold may be set manually via a user operating on the centralized platform and it may be performative (e.g., the data includes indicators that high performance is expected; active interrogation of models/sub-models, the previous threshold still remains most relevant; etc.); however, in a preferred embodiment, the performance threshold is established dynamically based on one or more previous iterations of modeling module 170. Classification module 210 is further configured to perform iterations to determine a corresponding risk assessment metric and a corresponding risk classification for dataset 130. Due to the fact that classification models will generally result in a risk assessment metric being in a particular class which is then converted to an actual predicted class, the risk assessment metric is described herein as the predicted class. Any appropriate machine learning model may be used to train the classifiers including but not limited to artificial neural networks, natural language classification, or any other applicable machine learning model known to those of ordinary skill in the art.

As classification module 210 performs iterations it is continuously storing the performance metrics (e.g., the confidence levels, f1 scores, or areas under precision-recall curves or the ROC curves associated) of the models derived from dataset 130 in database 160. Performance metrics of tickets may include but are not limited to categorical frequencies, language distribution, text length (i.e., number of words), vocabulary size, missing fields (e.g., flagging particular fields not being populated), parts of speech distribution, sparsity, entropy, percentage of words not in standardized dictionaries, or any other applicable ascertainable performance metric known to those of ordinary skill in the art. Upon classification module 210 determining model performance associated with dataset 130 as “unsatisfactory”, server 120 instructs an optimization module 220 to retrieve an applicable category from classification module 210 in order to create subsets 150. It should be noted that the determined categories may be exhaustive; however, one of the purposes of the categories is to indicate separability of labels of subsets 150, in other words whether the labels are able to be distinguished from each other in order to optimize classification. It should be further noted that if it is ascertainable that there is a significant variance between labels then it is an indicator that the applicable machine learned model of particular subsets 150 and/or derivatives thereof will perform well. Optimization module 220 utilizes the aforementioned data to determine which subsets of subsets 150 will be modeled by modeling module 170 in an iterative fashion. In some embodiments, optimization module 220 determines a plurality of candidate subsets within subset 150 based upon factors other than categories such as but not limited to ticket length, close codes, or any other applicable factor configured to be ascertained via the data profiling performed by selection/profiling module 140. For example, optimization module 220 is configured to distinguish between elements of dataset 130 by allocating a label of “problematic” or “non-problematic” to the respective elements in an iterative manner across categories established by classification module 210. A separate model generated by modeling module 170 is configured to be utilized for each of the plurality of candidate subsets in order to determine if model performance of the particular model is greater than the performance of the specific model associated with dataset 130.

Classification module 210 calculates the performance metrics between labels for a plurality of splits in which the splits may be generated utilizing a categorical variable, numerical variable, or any other applicable variable known to those of ordinary skill in the art. In some embodiments, classification module 210 is configured to model a feature-space derived from dataset 130 and/or subsets 150 in which each feature of the feature-space is a dimension allowing applicable search techniques (e.g., simulated annealing, etc.) to discover local extrema without exhausting all possible selection combinations; thus, reducing required computing resources for processing.

In some embodiments, server 120 is configured to utilized data derived from classification module 210 in order to generates reports configured to be presented on the centralized platform, in which the reports may include analytics associated with the performance metrics including but not limited to statistical distribution of labels, class-type fields, numeric fields, corpus-specific statistics, multi-label statistics, or any other applicable statistical distributions known to those of ordinary skill in the art.

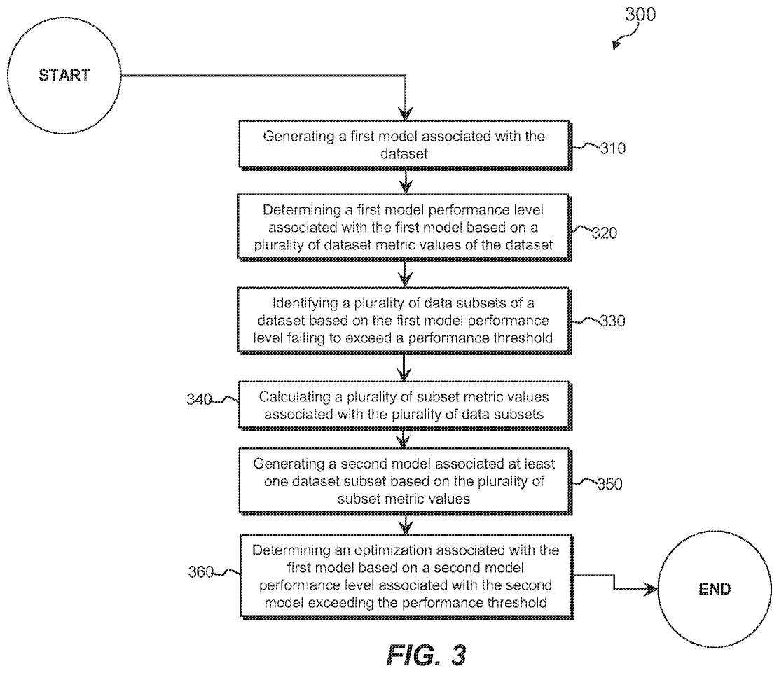

Referring now to FIG. 3, an operational flowchart illustrating an exemplary process for data selection 300 is depicted, according to at least one embodiment.

At step 310 of process 300, server 120 instructs modeling module 170 to generate a first model associated with dataset 130. It should be noted that the performance metrics of the first model may be ascertained based on server 120 comparing the respective generated performance metrics to the reference metrics generated by modeling module 170. The reference metrics may be utilized by server 120 to establish the performance threshold. In a preferred embodiment, the performance metrics are derived from an “F1 algorithm” in which a resulting F1 score may denote a measure of the accuracy of one or more tests associated with the first model and subsequent models considering the precision and the recall of the tests to compute the F1 score. In some embodiments, the precision may denote the number of correct positive results divided by the number of all positive results returned by a classifier, wherein the recall value is the number of correct positive results divided by the number of all relevant samples (all samples that should have been identified as positive). The F-score may also be seen as the harmonic average of the precision and recall, were an F-score reaches its best value at 1 (perfect position and perfect recall) and worst at 0. In some embodiments, optimization module 220, alone or in combination with server 120, is configured to determine an optimization associated with the first model based upon one or more elements associated with subsequent models (i.e., models associated with subsets 150) in which the one or more elements may include but are not limited to processing time, gradient descent, maxima, minima, or any other applicable component indicating a distinction between the functioning of two or more artificial intelligence models.

In some embodiments, modeling module 170 includes one or more training modules configured to train a machine learning model based on data derived from dataset 130. During iterations of training the first model, server 120 is designed to utilize one or more efficiency engines to model and predict distributions configured to assist forecasting for applicable down-stream systems. The training modules utilize training samples derived from dataset 130 and their associated labels to train the first model via a supervised learning process in which applicable model parameters are continuously updated. Server 120 is further configured to support decision optimization and meta modeling based on data derived from dataset 130 and the training modules in order to provide updateable/optimized models and data structures; however, dataset 130 may be continuously filtered in order to ascertain relevant tickets within. For example, server 120 may instruct modeling module 170 to disregard tickets lacking a valid close code. In some embodiments, the outputs of one or more models generated by modeling module 170 is a trained pipeline configured to be used to optimize labeling of the model as “satisfactory” or “non-satisfactory” based on the performance metrics that are actively being ascertained during iterations. The trained pipeline may be configured so that tickets for testing and tickets for training are distinct and pooled separately allowing data selecting factors for datasets to be combined to assist with filtration. For example, F1 scores of sub-models of subsets 150 may be compared to F1 scores of the full model of dataset 130 in order for selection/profiling module 140 to determine which selecting factors are applicable for optimal testing.

At step 320 of process 300, classification module 210 determines a performance level associated with the first model based on the dataset metric values of dataset 130 indicating performance. Selection/profiling module 140 utilizes the pre-configured filters derived from server 120 to process tickets within dataset 130 and ascertain data such as close codes associated with applicable tickets. The performance level of the first model is critical in respect to determining sufficient performance of subsequent models derived from subsets 150 because the performance threshold of the first model is used as the minimum standard to ascertain optimization of each respective model.

At step 330 of process 300, server 120 instructs selection/profiling module 140 to identify subsets 150 within dataset 130 based on the performance level of the first model failing to exceed the performance threshold. It should be noted that identification of subsets 150 may be the result of one or more mapping functions performed by selection/profiling module 140 that assign the tickets across subsets 150 and/or derivatives thereof. In some embodiments, it is necessary to repeat the mapping functions for newer tickets when modeling module 170 performs future modeling.

Classification module 210 includes functionality to generate subsets 150 to be classified to the partially or fully trained model in order to obtain classification results or class assignments for one or more components of subsets 150. In some embodiments, classification module 210 generates true labels and class assignments for subsets 150 resulting in server 120 and/or selection/profiling module 140 mapping close codes of tickets to “problematic” or “non-problematic” labels or any other applicable label generated by classification module 210. For example, classification module 210 labels tickets using an “incident” or “non-incident” label in order to assist the labeling process in filtering tickets. In addition, server 120 simultaneously instructs processing of dataset 130 that results in the removal of undesired expressions of tickets that otherwise complicate labeling of data derived from dataset 130 and subsets 150. For example, tickets impacted by external causes such as but not limited to personnel changes, management decisions, etc. are not likely to be informative to rendered models; thus, tickets that include indications such as cancellation, abandonment, etc. may be classified as potential candidates that may never be utilized by modeling module 170.

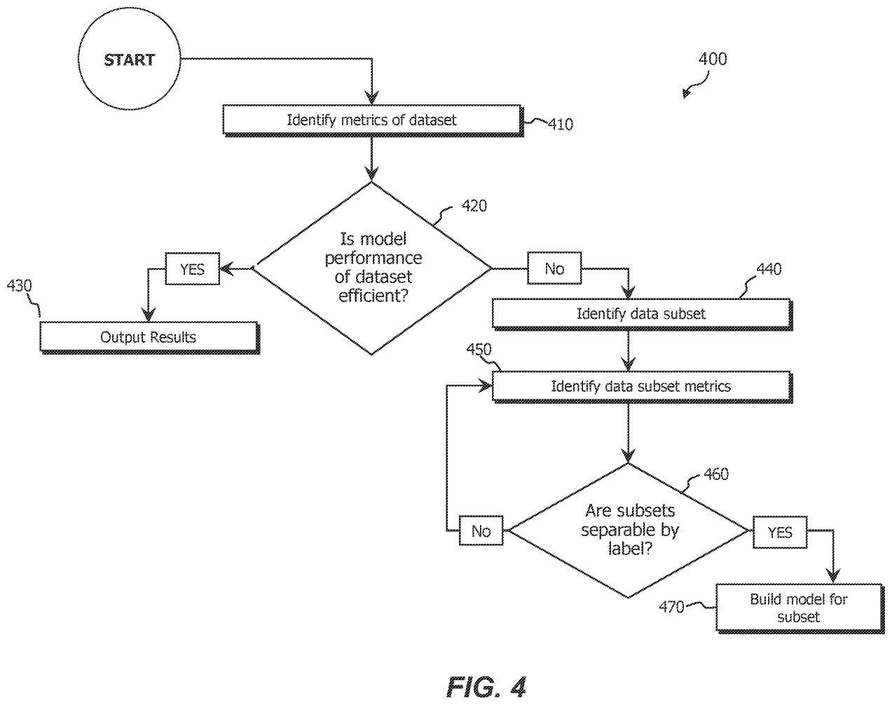

At step 340 of process 300, server 120 calculates a plurality of subset metric values associated with one or more of subsets 150. As noted above, calculation of metrics may utilize a variety of methods in order to ascertain the most useful and efficient metrics. For example, classification module 210 may generate class-specific performance metrics, performance metrics may be derived from subsets of classes, and/or classification module 210 may generate predicted performance metrics indicating predicted improvement towards model performance targets. An advantage of the operations of classification module 210 is that labeling is performed without requiring an associated domain-specific corpus. Instead, classification module 210 concatenates text components of the tickets and applies stemming/lemmatization in order to generate a relevant corpus and supporting tokenized vectors to more efficiently ascertain the performance metrics. Simultaneously, classification module 210 is continuously monitoring subsets 150 in order to ascertain whether subsets 150 are separatable by label, which is discussed in greater detail in reference to FIG. 4.

At step 350 of process 300, server 120 instructs modeling module 170 to generate a second model associated with at least one subset within subsets 150 based on the plurality of subset metric values. The second model is trained based on data derived from at least one of subsets 150. It should be noted that the purpose of generating the second model is to ascertain whether the model performance of the second model is of higher performance than that of the first model in which the performance of the second model is compared to that of the first model and the reference metrics.

At step 360 of process 300, server 120 determines an optimization associated with the first model based on a second model performance level associated with the second model exceeding the performance threshold. It should be noted that the performance level of the second model exceeding the performance threshold inherently indicates that the model performance of the second model is an optimization of that of the first model due to the fact that the selection of the applicable subset is based upon insufficient model performance of the first model.

Referring now to FIG. 4, an operational flowchart illustrating an exemplary process for data profiling 400 is depicted, according to at least one embodiment.

At step 410 of process 400, server 120 identifies metrics of dataset 130. In some embodiments, the identification of metrics of dataset 130 requires not only the generation of the first model by modeling module 170, but also the application of pre-processing and pre-configured filters in order to ascertain metrics without requiring user definitions. This feature is relevant considering that selection/profiling module 140 performs text profiling in a comparative manner across the classes as opposed to over dataset 130 overall. The identification of the metrics is configured to leverage the automated functioning of selection/profiling module 140 in its data selection for subsets 150 by allowing server 120 to ascertain differences between classes.

At step 420 of process 400, server 120 makes a determination as to whether the performance of the first model is efficient. As previously mentioned, due to the lack of data at this point in time of the process, server 120 may require that the performance threshold be established based upon either an applicable threshold designed to be ascertained from the one or more reference metrics or that the performance threshold be established via inputs received on the centralized platform. If server 120 determines that the performance of the first model exceeds the performance threshold, then step 430 occurs in which modeling module 170 generates one or more outputs and the process ends; however, if the performance of the first model does not exceed the performance threshold then step 440 occurs.

At step 440 of process 400, server 120 identifies one or more subsets 150 of dataset 130. Data selection via selection/profiling module 140 is contingent upon server 120 determining that performance of the first model is not satisfactory and that data profiling is necessary in order to ascertain the appropriate data subsets of dataset 130. Selection/profiling module 140 is configured to select the most promising data subsets subject to various implementations. For example, selection/profiling module 140 may monitor dataset 130 for tickets having class-type fields including a small number of values (e.g. ticket type may be “normal” or “emergency”), in which case all combinations of values might be tried, or fields that are sometimes not supplied with values, so those tickets may be excluded from evaluation by modeling module 170. In another example, additional data contained within the tickets may be utilized to filter dataset 130 into subsets (i.e., date ranges, groups of days, etc.).

At step 450 of process 400, server 120 calculates subset metric values of subset 150. As previously described, the types of performance metrics calculated may not be exhaustive; however, various performance metrics provided herein allow for unconventional measurements of optimization associated with the tickets. For example, selection/profiling module 140 may calculate the percentage of words within the textual descriptions of the tickets not included within standardized dictionaries in order to assist profiling and selection of subsets 150 which would indicate a higher model performance than the first model; however, it is imperative to note that the profiling of the texts within the tickets is performed across the classes generated by classification module 210 in a comparative manner allowing efficiency and optimization to compound upon iterations. In addition, subsets may be re-trained in order to ascertain additional or supplemental performance metrics. In some embodiments, the performance metrics includes statistical distribution of labels, class-type fields, numeric fields, corpus-specific statistics, multi-label statistics, or any other applicable statistical distributions.

At step 460 of process 400, server 120 makes a determination as to whether subsets 150 are separable by the label generated by classification module 210. If server 120 determines that subsets 150 are not separable by label then server 120 continues to ascertain performance metrics of one or more additional subsets of dataset 130; however, if server 120 determines that the applicable subsets are separable by label then server 120 continues to step 470. It should be noted that determination of separability of labels may be accomplished in a variety of ways; however, in a preferred embodiment, a text proportionality threshold (e.g., amount of content of tickets not included in a standardized dictionary, etc.) is established via server 120 based on an initial threshold derived from the separability of labels of dataset 130. Similar to the performance threshold, the initial threshold may also be manually set by a user operating on the centralized platform. In some embodiments, the determination regarding separability of labels is based upon one or more output metrics of modeling module 170. These output metrics may include but are not limited to Jensen-Shannon divergence, Cramer's V correlations, mean squared difference, normalized cross correlation, sum of squared differences, Kullback-Leibler divergence, or any other applicable metric configured to assist calculation of the difference between true label distributions of training data subsets. In some embodiments, optimization module 220 is configured to perform metric convergence analysis on the one or more output metrics of modeling module 170.

At step 470 of process 400, server 120 instructs modeling module 170 to generate the second model. Modeling module 170 generates the second model based upon training data sets derived from the applicable subsets 150 and/or derivatives thereof. It should be noted that one of the purposes of generating the second model is to ascertain via the respective labels whether the model performance of the second model associated with the applicable of subset 150 or derivative thereof is at a higher performance level than that of the first model. In some embodiments, if the performance level associated with the second model exceeds the performance threshold then server 120 receives an indicator that the applicable subset is more efficient and this can be confirmed by server 120 comparing the performance metrics of the respective models via the labels of the respective models. It should be noted that the ascertained performance on subsets 150 along with derived test and training data is indicative of performance with future data for which the applicable model will be used; however, server 120 is configured to utilize modeling module 170 to determine assignments of a particular subset 150 associated with a newer ticket based upon whether the particular subset was or could have been available when original models were built (e.g., models built based on dataset 130). In some embodiments, the aforementioned data is ascertainable based on one or more previous iterations of modeling module 170.

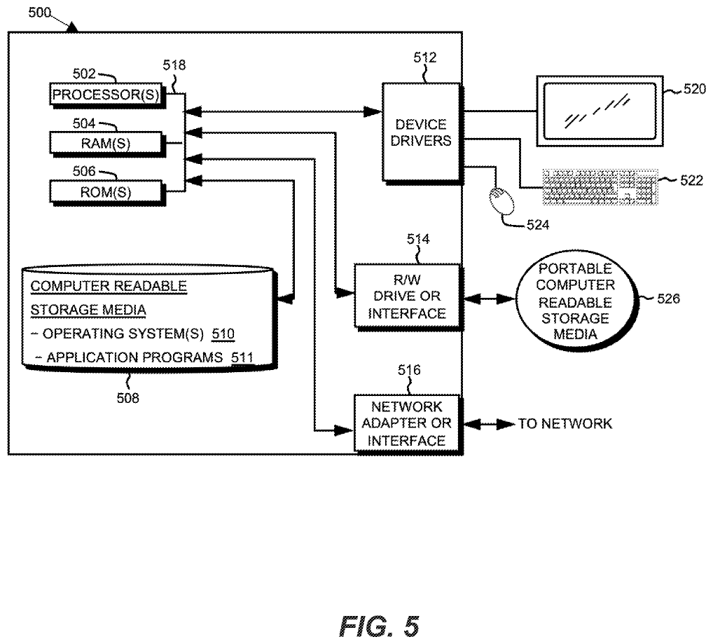

FIG. 5 is a block diagram of components 500 of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 502, 504 is representative of any electronic device capable of executing machine-readable program instructions. Data processing system 502, 504 may be representative of a smart phone, a computer system, PDA, or other electronic devices. Examples of computing systems, environments, and/or configurations that may represented by data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The one or more servers may include respective sets of components illustrated in FIG. 5. Each of the sets of components include one or more processors 502, one or more computer-readable RAMs 508 and one or more computer-readable ROMs 510 on one or more buses 502, and one or more operating systems 514 and one or more computer-readable tangible storage devices 516. The one or more operating systems 514 and computing event management system 210 may be stored on one or more computer-readable tangible storage devices 516 for execution by one or more processors 502 via one or more RAMs 508 (which typically include cache memory). In the embodiment illustrated in FIG. 5, each of the computer-readable tangible storage devices 516 is a magnetic disk storage device of an internal hard drive. Alternatively, each of the computer-readable tangible storage devices 516 is a semiconductor storage device such as ROM 510, EPROM, flash memory or any other computer-readable tangible storage device that can store a computer program and digital information.

Each set of components 500 also includes a R/W drive or interface 514 to read from and write to one or more portable computer-readable tangible storage devices 508 such as a CD-ROM, DVD, memory stick, magnetic tape, magnetic disk, optical disk or semiconductor storage device. A software program, such as computing event management system 210 can be stored on one or more of the respective portable computer-readable tangible storage devices 508, read via the respective RAY drive or interface 518 and loaded into the respective hard drive.

Each set of components 500 may also include network adapters (or switch port cards) or interfaces 516 such as a TCP/IP adapter cards, wireless wi-fi interface cards, or 3G or 4G wireless interface cards or other wired or wireless communication links. COP 120 can be downloaded from an external computer (e.g., server) via a network (for example, the Internet, a local area network or other, wide area network) and respective network adapters or interfaces 516. From the network adapters (or switch port adaptors) or interfaces 516, the centralized platform is loaded into the respective hard drive 508. The network may comprise copper wires, optical fibers, wireless transmission, routers, firewalls, switches, gateway computers and/or edge servers.

Each of components 500 can include a computer display monitor 520, a keyboard 522, and a computer mouse 524. Components 500 can also include touch screens, virtual keyboards, touch pads, pointing devices, and other human interface devices. Each of the sets of components 500 also includes device processors 502 to interface to computer display monitor 520, keyboard 522 and computer mouse 524. The device drivers 512, R/W drive or interface 518 and network adapter or interface 518 comprise hardware and software (stored in storage device 504 and/or ROM 506).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

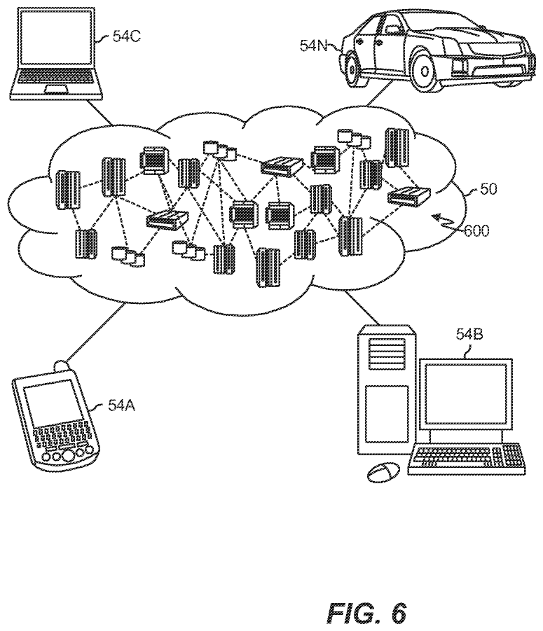

Referring now to FIG. 6, illustrative cloud computing environment 600 is depicted. As shown, cloud computing environment 600 comprises one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 54A-N shown in FIG. 6 are intended to be illustrative only and that computing nodes 50 and cloud computing environment 600 can communicate with any type of computerized device over any type of network and/or network addressable connection (e.g., using a web browser).

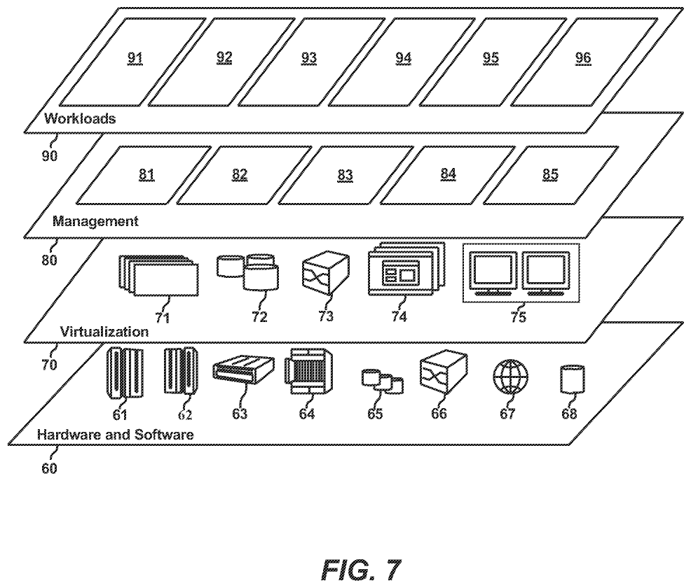

Referring now to FIG. 7 a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 66 and database software 68.

Virtualization layer 60 provides an abstraction layer from which the following examples of virtual entities may be provided: virtual servers 61; virtual storage 62; virtual networks 63, including virtual private networks; virtual applications and operating systems 64; and virtual clients 65.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method using a computing device for data selection for use with an artificial intelligence model, the method comprising:
generating, by the computing device, a first model associated with a dataset;
determining, by the computing device, a first model performance level associated with the first model based on a plurality of dataset metric values associated with the dataset;
identifying, by the computing device, a plurality of data subsets of the dataset based on the first model performance level failing to exceed a performance threshold;
calculating, by the computing device, a plurality of subset metric values associated with the plurality of data subsets;
generating, by the computing device, a second model associated with at least one data subset based on the plurality of subset metric values; and
determining, by the computing device, an optimization associated with the first model based on a second model performance level associated with the second model exceeding the performance threshold.

2. The computer-implemented method of claim 1 further comprising:
generating by the computing device, one or more outputs of the first model upon the one or more outputs exceeding the performance threshold.

3. The computer-implemented method of claim 2, further comprising:
generating by the computing device, a third model associated with at least one data subset different from the data subset of the second test model upon the one or more outputs failing to exceed the performance threshold.

4. The computer-implemented method of claim 2, wherein calculating a plurality of subset metric values comprises:
performing, by the computing device, data profiling on the dataset, the profiling generating the plurality of subset metric values.

5. The computer-implemented method of claim 4, wherein performing data profiling on the dataset comprises:
applying, by the computing device, a plurality of filters to the dataset resulting in a plurality of close codes associated with the dataset;
mapping, by the computing device, the plurality of close codes to a plurality of labels associated with a plurality of tickets derived from the dataset.

6. The computer-implemented method of claim 4, wherein performing data profiling on the dataset further comprises:
determining, by the computing device, a separability of the plurality of labels;
wherein the second model is configured to process the at least one data subset based on the separability.

7. The computer-implemented method of claim 1, wherein identifying the plurality of data subsets of the dataset comprises:
removing, by the computing device, a plurality of undesired expressions from the dataset.

8. A computer system for data selection for models, the computer system comprising:
one or more processors, one or more computer-readable memories, and program instructions stored on at least one of the one or more computer-readable memories for execution by at least one of the one or more processors to cause the computer system to:
program instructions to generate a first model associated with a dataset;
program instructions to determine a first model performance level associated with the first model based on a plurality of dataset metric values associated with the dataset;
program instructions to identify a plurality of data subsets of the dataset based on the first model performance level failing to exceed a performance threshold;
program instructions to calculate a plurality of subset metric values associated with the plurality of data subsets;
program instructions to generate a second model associated with at least one data subset based on the plurality of subset metric values; and
program instructions to determine an optimization associated with the first model based on a second model performance level associated with the second model exceeding the performance threshold.

9. The computer system of claim 9, further comprising computer instructions to:
generate one or more outputs of the first model upon the one or more outputs exceeding the performance threshold.

10. The computer system of claim 10, further comprising computer instructions to:
generate a third model associated with at least one data subset different from the data subset of the second test model upon the one or more outputs failing to exceed the performance threshold.

11. The computer system of claim 10, wherein program instructions to calculate a plurality of subset metric values further comprises program instructions to:
perform data profiling on the dataset, the profiling generating the plurality of subset metric values

12. The computer system of claim 11, wherein program instructions to perform data profiling further comprises program instructions to:
apply a plurality of filters to the dataset resulting in a plurality of close codes associated with the dataset;
map the plurality of close codes to a plurality of labels associated with a plurality of tickets derived from the dataset.

13. The computer system of claim 11, wherein program instructions to perform data profiling further comprises program instructions to:
determine a separability of the plurality of labels;
wherein the second model is configured to process the at least one data subset based on the separability.

14. The computer system of claim 9, wherein program instructions to identify the plurality of data subsets of the dataset further comprises program instructions to:
remove a plurality of undesired expressions from the dataset.

15. A computer program product using a computing device for data selection, comprising:
one or more non-transitory computer-readable storage media and program instructions stored on the one or more non-transitory computer-readable storage media, the program instructions, when executed by the computing device, cause the computing device to perform a method comprising:
generating, by the computing device, a first model associated with a dataset;
determining, by the computing device, a first model performance level associated with the first model based on a plurality of dataset metric values associated with the dataset;
identifying, by the computing device, a plurality of data subsets of the dataset based on the first model performance level failing to exceed a performance threshold;
calculating, by the computing device, a plurality of subset metric values associated with the plurality of data subsets;
generating, by the computing device, a second model associated with at least one data subset based on the plurality of subset metric values; and
determining, by the computing device, an optimization associated with the first model based on a second model performance level associated with the second model exceeding the performance threshold.

16. The computer program product of claim 15, comprising instructions to further cause the computing device to perform a method comprising:
generating by the computing device, a third model associated with at least one data subset different from the data subset of the second test model upon the one or more outputs failing to exceed the performance threshold.

17. The computer program product of claim 16, wherein calculating a plurality of subset metric values comprises:
performing, by the computing device, data profiling on the dataset, the profiling generating the plurality of subset metric values.

18. The computer program product of claim 17, wherein performing data profiling on the dataset comprises:
applying, by the computing device, a plurality of filters to the dataset resulting in a plurality of close codes associated with the dataset; and
mapping, by the computing device, the plurality of close codes to a plurality of labels associated with a plurality of tickets derived from the dataset.

19. The computer program product of claim 17, wherein performing data profiling on the dataset further comprises:
determining, by the computing device, a separability of the plurality of labels;
wherein the second model is configured to process the at least one data subset based on the separability.

20. The computer program product of claim 15, wherein identifying the plurality of data subsets of the dataset comprises:
removing, by the computing device, a plurality of undesired expressions from the dataset.
